(19) United States
(12) Patent Application Publication
(10) Pub. No.: US 2026/0233087 A1
(43) Pub. Date: Aug. 13, 2026

(54) INFORMATION PRESENTATION DEVICE, INFORMATION PRESENTATION METHOD, AND INFORMATION PRESENTATION PROGRAM

(71) Applicant: NTT, Inc., Tokyo (JP)

(72) Inventors: Takeru ISAKA, Musashino-shi, Tokyo (JP); Yoko TOKUNAGA, Musashino-shi, Tokyo (JP); Iwaki TOSHIMA, Musashino-shi, Tokyo (JP); Takao NAKAMURA, Musashino-shi, Tokyo (JP)

(73) Assignee: NTT, Inc., Tokyo (JP)

(21) Appl. No.: 19/148,005

(22) PCT Filed: Jan. 17, 2023
(86) PCT No.: PCT/JP2023/001228

§ 371 Date: Jul. 15, 2025

(51) Int. Cl. A63F 3/00; G09B 19/22

(52) U.S. Cl. CPC A63F 3/00895; G09B 19/22

(57) ABSTRACT

An information presentation device includes a memory and processing circuitry configured to acquire a degree of emotion felt by a first evaluator and the degree of emotion felt by a second evaluator for each of a series of actions performed by a human, and present information obtained by comparing the degree of emotion felt by the first evaluator with the degree of emotion felt by the second evaluator.

### TECHNICAL FIELD

The present invention relates to an information presentation device, an information presentation method, and an information presentation program.

### BACKGROUND ART

Japanese chess, a type of board game, is known. Beginners in Japanese chess can improve their skills by memorizing the roles of the pieces and repeatedly practicing the standard moves. On the other hand, it is difficult to further enhance the skills of professional players, who already possess the highest level of skill among humans. Professional Japanese chess players are taught how to win from an early age, so their skills are already mature, and they have limited room for growth. The skills of professional players tend to reach a plateau at certain ages after they are promoted to professional status.

The primary method for professional players to learn Japanese chess is by discovering and learning strong moves and strong flows from a vast amount of past game results (game records).

In addition to Japanese chess played by humans, the game records also include Japanese chess played by AI, which has recently boasted superior skills to humans. Studies of such game records suggest that players will be able to learn moves that they can understand, that is, moves played by players of the same rank or slightly higher than themselves. On the other hand, to become stronger, professional players must understand the mechanisms of strong moves played by others with higher skills than themselves and be able to use them in actual games. However, there is a problem in that it is difficult to understand and retain game records played by others with higher skills than oneself.

Traditionally, learning methods have been proposed to improve Japanese chess skills. For example, NPL 1 describes a learning support system that allows learners to improve their skills independently by presenting board states that are likely to be formed two moves or more ahead rather than providing direct hints about the board state during a game.

### CITATION LIST

### Non Patent Literature

[NPL 1] Takeshi Ito: Game Learning Support System based on Future Position, ICGA Journal, vol. 40, no. 4, pp. 450-459 (2018).

### SUMMARY OF INVENTION

### Technical Problem

However, the conventional technology has a problem that it may be difficult to learn the sensibility of an expert regarding actions.

For example, the technology described in NPL 1 only presents the board state, and cannot convey the sensibility of an expert regarding the board state to the learner. As a result, the learner cannot learn what sensibility is the basis for selecting a move.

### Solution to Problem

In order to solve the above problem and achieve the object, an information presentation device includes: an acquisition unit that acquires a degree of emotion felt by a first evaluator and the degree of emotion felt by a second evaluator for each of a series of actions performed by a human; and a presentation unit that presents information obtained by comparing the degree of emotion felt by the first evaluator with the degree of emotion felt by the second evaluator.

### Advantageous Effects of Invention

According to the present invention, it is possible to learn the sensibilities of an expert regarding actions.

### BRIEF DESCRIPTION OF DRAWINGS

FIG. 1 is a diagram explaining an information presentation device and an evaluator.

FIG. 2 is a diagram explaining an information presentation device and an evaluator.

FIG. 3 is a diagram for explaining an information presentation device and an evaluator.

FIG. 4 is a diagram for explaining an example of the configuration of an information presentation device according to a first embodiment.

FIG. 5 is a diagram illustrating an example of an input screen.

FIG. 6 is a diagram illustrating an example of a sensibility information DB.

FIG. 7 is an example of a graph plotting values in the “pleasant-unpleasant” column.

FIG. 8 is an example of a graph plotting values in the “intense-calm” column.

FIG. 9 is an example of a graph plotting values in the “situation” column.

FIG. 10 is a flowchart for explaining the processing flow of the information presentation device according to the first embodiment.

FIG. 11 is a diagram illustrating an example of a computer that executes an information presentation program.

### DESCRIPTION OF EMBODIMENTS

Below, embodiments of the information presentation device, information presentation method, and information presentation program according to the present application will be described in detail with reference to the drawings. Note that the present invention is not limited to the embodiments described below.

### First embodiment

The information presentation device of the first embodiment supports a learner in learning the way an expert thinks and feels when performing a series of actions.

In the series of actions, a strategy is determined for each action.

The series of actions is, for example, a board game in which two players alternately place pieces and play against each other. In the present embodiment, the series of actions is assumed to be Japanese chess. The series of actions may also be other board games such as chess. In this way, the information presentation device 10 can support the learning of board games such as Japanese chess.

The information presentation device of the present embodiment acquires the degree of emotion of an evaluator who evaluates a series of actions. The evaluator may be the subject of the series of actions (for example, a player of a board game or the like) or may be an observer of the series of actions.

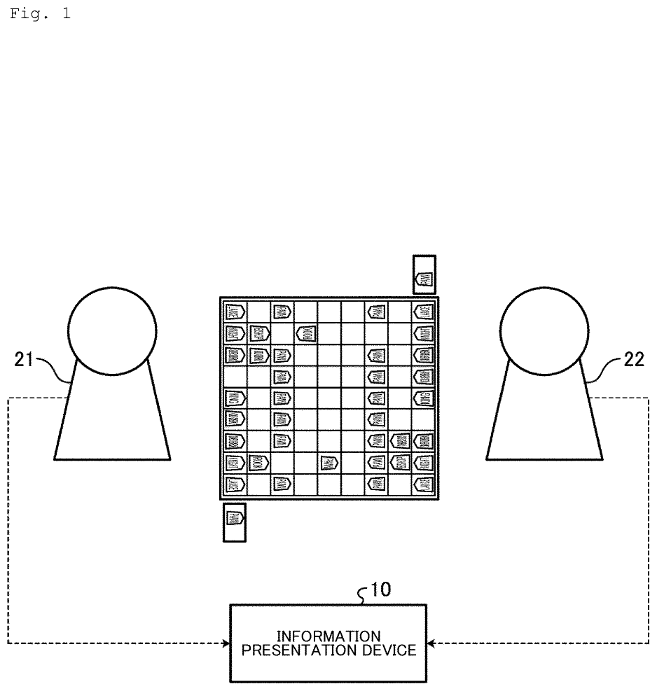

The information presentation device and the evaluator will be described below with reference to FIGS. 1, 2, and 3. FIGS. 1, 2, and 3 are diagrams for explaining the information presentation device and the evaluator.

As illustrated in FIG. 1, an evaluator 21 and an evaluator 22 play Japanese chess. The evaluator 21 and the evaluator 22 are opponents in the game of Japanese chess. In the example of FIG. 1, both the evaluator 21 and the evaluator 22 are the subjects of a series of actions.

The information presentation device 10 acquires the degrees of emotion of the evaluator 21 and the evaluator 22. Details of how the information presentation device 10 acquires the degree of emotion will be described later.

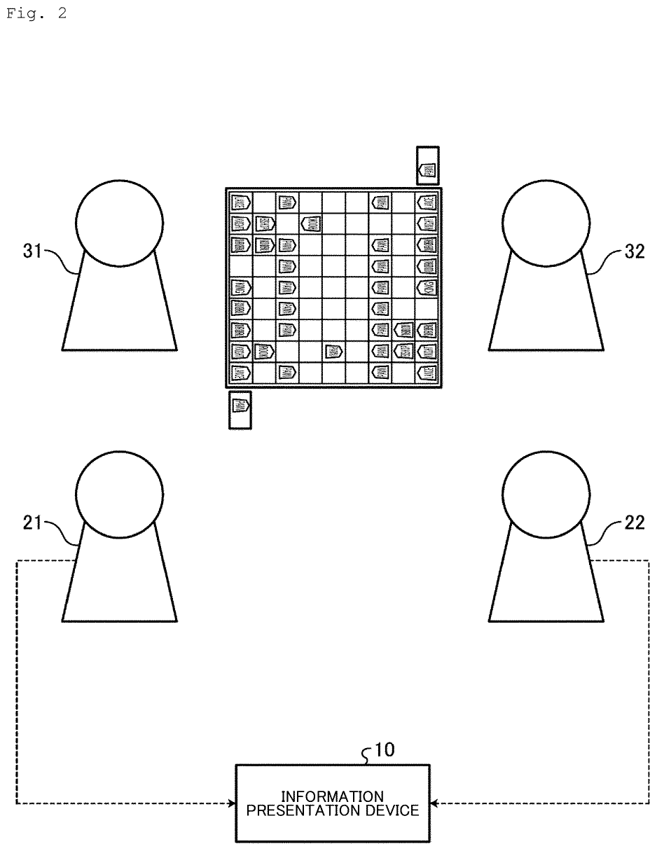

As illustrated in FIG. 2, the evaluator 21 and the evaluator 22 watch the game of Japanese chess played by a player 31 and a player 32. In the example of FIG. 2, both the evaluator 21 and the evaluator 22 are observers of a series of actions. In the following description, the evaluator 21 and the evaluator 22 may be simply referred to as an evaluator without distinction.

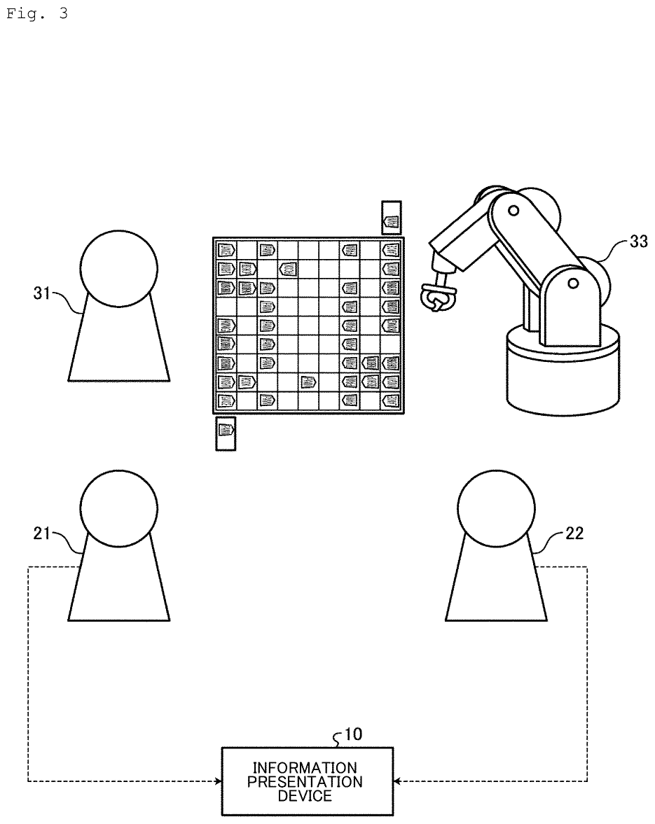

As illustrated in FIG. 3, one (or both) of the Japanese chess players may be a robot. The robot 33 plays Japanese chess according to the judgment of a program (such as a so-called Japanese chess AI). Note that the player may be a human who operates the pieces according to the AI instructions.

### [Configuration of First Embodiment]

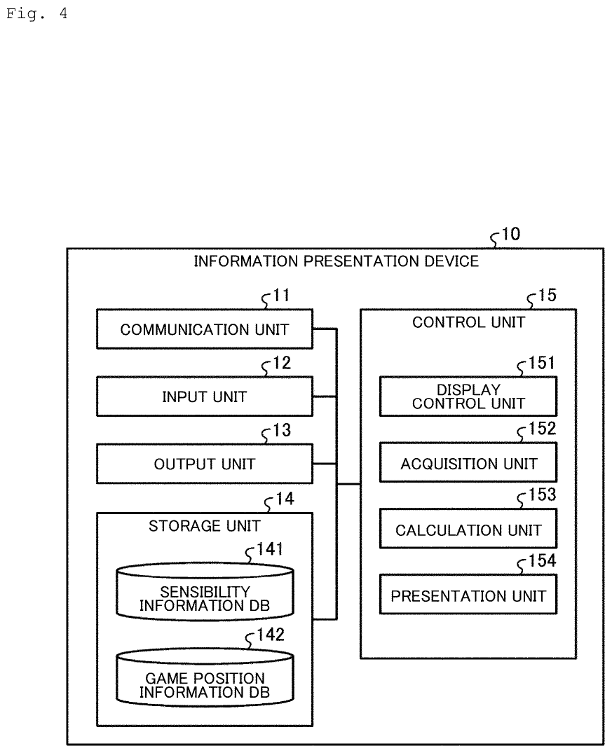

The configuration of the information presentation device according to the first embodiment will be described with reference to FIG. 4. FIG. 4 is a diagram illustrating an example of the configuration of the information presentation device according to the first embodiment.

As illustrated in FIG. 4, the information presentation device 10 has a communication unit 11, an input unit 12, an output unit 13, a storage unit 14, and a control unit 15.

The communication unit 11 performs data communication with other devices via a network. The communication unit 11 is, for example, a network interface card (NIC). The input unit 12 accepts data input from a user. The input unit 12 is connected to an input device such as a mouse and a keyboard.

The output unit 13 outputs data by displaying a screen or the like. The output unit 13 is, for example, a display device such as a display.

The storage unit 14 is a storage device, such as a hard disk drive (HDD), a solid state drive (SSD), or an optical disk. The storage unit 14 may be a semiconductor memory capable of rewriting data, such as a random access memory (RAM), a flash memory, and a nonvolatile static random access memory (NVSRAM). The storage unit 14 stores an operating system (OS) and various programs executed by the information presentation device 10.

The storage unit 14 stores a sensibility information DB 141 and a game position information DB 142. The sensibility information DB 141 includes the degree of emotion or the like input by the evaluator. The game position information DB 142 is information on each game position of Japanese chess, for example, information indicating the placement of pieces. The game position information DB 142 may be an image of the game board at each game position.

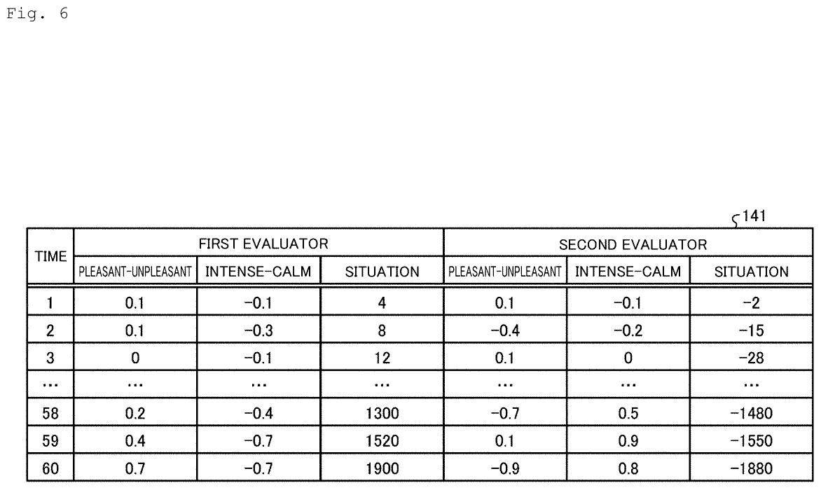

FIG. 6 is a diagram illustrating an example of the sensibility information DB. As illustrated in FIG. 6, the sensibility information DB 141 is a table. The sensibility information DB 141 has a “time” column. The sensibility information DB 141 also has a “pleasant-unpleasant” column, an “intense-calm” column, and a “situation” column for each of the first and second evaluators. The values of each column will be described in detail later.

The control unit 15 controls the entire information presentation device 10. The control unit 15 is, for example, an electronic circuit such as a central processing unit (CPU), a micro processing unit (MPU), or a graphics processing unit (GPU), or an integrated circuit such as an application specific integrated circuit (ASIC) or a field programmable gate array (FPGA). The control unit 15 includes an internal memory that stores a program defining various types of processing procedures and control data, and executes each step of processing using the internal memory. Also, the control unit 15 functions as various processing units as a result of various programs operating. For example, the control unit 15 has a display control unit 151, an acquisition unit 152, a calculation unit 153, and a presentation unit 154.

The display control unit 151 generates a screen. The display control unit 151 displays the generated screen on a display device such as a display via the output unit 13.

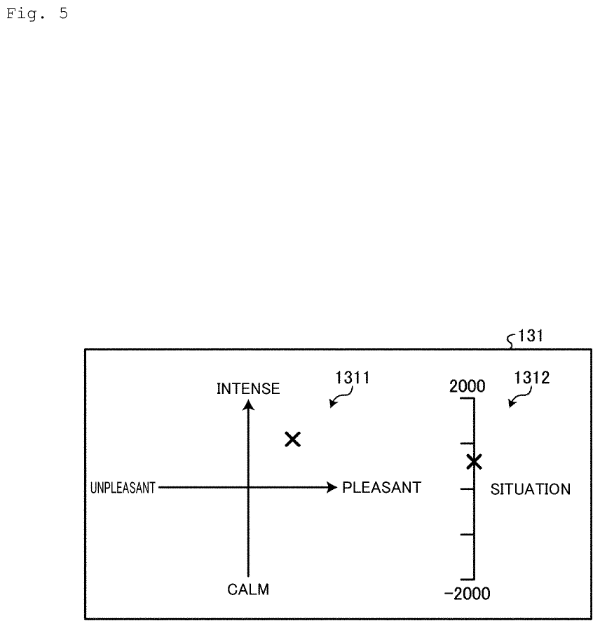

The display control unit 151 generates an input screen for the evaluator to input the degree of emotion or the like. The input screen will be described with reference to FIG. 5. FIG. 5 is a diagram illustrating an example of an input screen.

As illustrated in FIG. 5, the display control unit 151 displays a plot area 1311 for inputting the degree of emotion and a plot area 1312 for inputting the situation on the input screen 131.

The plot area 1311 is a coordinate plane including a vertical axis and a horizontal axis. The vertical axis corresponds to the degree of momentum (intensity or calmness) felt by the evaluator with respect to the move made by the player. The horizontal axis corresponds to the degree of pleasantness felt by the evaluator with respect to the move made by the player. Note that a move is, for example, the act of moving a piece in Japanese chess.

The plot area 1312 is a line with a scale indicating the situation in a Japanese chess match. The evaluator, based on his/her subjective judgment, gives a higher value to the situation the greater an advantage one player has. Conversely, the evaluator, based on his/her subjective judgment, gives a lower value to the situation the greater a disadvantage one player has.

The evaluator plots on the coordinate plane of the plot area 1311 and on the line of the plot area 1312. For example, the evaluator can plot by clicking a mouse, tapping a touch panel, or the like.

For example, if the evaluator feels that the player's move is intense and pleasant, the evaluator plots in the first quadrant of the coordinate plane of the plot area 1311. Also, for example, if the evaluator feels that a predetermined player is dominant, the evaluator plots the position above the center of the line in the plot area 1312.

The range of the vertical and horizontal axes of the coordinate plane of the plot area 1311 is, for example, from −1 to 1. The range of the situation is, for example, from −2000 to 2000 (based on the general evaluation of Japanese chess software).

In the present embodiment, the information presentation device 10 obtains the degree of momentum, the degree of pleasantness, and the situation as the evaluator's sensibility information. The combination of these pieces of sensibility information is an example of a combination that is considered to be effective for learning Japanese chess based on interviews with professional Japanese chess players and knowledge of psychology. The sensibility information obtained by the information presentation device 10 is not limited to that described herein.

The range of each index may be determined by the following calibration. That is, first, the evaluator is presented with game positions in which one player has a decisive advantage or disadvantage or is intense or calm in Japanese chess. Then, the evaluator's sensibility information (degree of momentum, degree of pleasantness, and situation) for the presented game positions is acquired. The acquired sensibility information is set to the maximum or minimum value of each sensibility information (degree of momentum, degree of pleasantness, and situation). For example, the degree of momentum felt by the evaluator for a decisively intense game position is set to the maximum degree of momentum.

The game positions presented to the evaluator may be changed according to the evaluator's playing style or the like. For example, if the evaluator's playing style as a player is what is called a “swinging rook player,” it is conceivable that the evaluator will be presented with game positions that are decisively pleasant or unpleasant for a player whose playing style is a “swinging rook player.” Such game positions may not be particularly pleasant or unpleasant for a player whose playing style is not a “swinging rook player.”

The information presentation device 10 may normalize the sensibility information input to the input screen 131 based on the maximum and minimum values obtained by the above method.

The display control unit 151 stores the sensibility information input to the input screen 131 in the sensibility information DB 141. The process of accepting input from the evaluators and storing the sensibility information in the sensibility information DB 141 may be called annotation.

As illustrated in FIGS. 1, 2, and 3, two evaluators each make input to the input screen 131. The evaluator 21 is the first evaluator. The evaluator 22 is the second evaluator.

The display control unit 151 stores values in the “pleasant-unpleasant” column (range: −1 to 1), the “intense-calm” column (range: −1 to 1), and the “situation” column (range: −2000 to 2000) of the first evaluator in the sensibility information DB 141 based on the coordinates of the points plotted by the evaluator 21 on the coordinate plane of the plot area 1311 and the positions of the points plotted on the line of the plot area 1312.

The display control unit 151 stores values in the “pleasant-unpleasant” column, the “intense-calm” column, and the “situation” column of the first evaluator in the sensibility information DB 141 based on the coordinates of the points plotted by the evaluator 21 on the coordinate plane of the plot area 1311 and the positions of the points plotted on the line of the plot area 1312. The “time” column of the sensibility information DB 141 indicates the number of moves in the corresponding game position.

In the example of FIG. 6, the sensibility information DB 141 shows that the degree of pleasantness felt by the first evaluator for the first move was “0.1” (slightly pleasant), the degree of intensity was “−0.1” (slightly calm), and the situation was “4” (slightly advantageous).

In addition, in the example of FIG. 6, the sensibility information DB 141 shows that the second evaluator's degree of pleasantness for the first move was “0.1” (slightly pleasant), the degree of intensity was “−0.1” (slightly calm), and the situation was “−2” (slightly disadvantageous).

In the example of FIG. 6, the sensibility information DB 141 indicates that the degree of pleasantness felt by the first evaluator for the 60th move was “0.7” (very pleasant), the degree of intensity was “−0.7” (very calm), and the situation was “1900” (very advantageous).

In the example of FIG. 6, the sensibility information DB 141 indicates that the degree of pleasantness felt by the second evaluator for the 60th move was “−0.9” (very unpleasant), the degree of intensity was “0.8” (very intense), and the situation was “−1880” (very disadvantageous).

The acquisition unit 152 acquires the degree of emotion felt by the first evaluator and the degree of emotion felt by the second evaluator for each of a series of actions performed by a human. The acquisition unit 152 acquires the degree of emotion felt by the first evaluator and the degree of emotion felt by the second evaluator for each piece placement by each player in a board game in which two players alternately place pieces to play against each other.

That is, the acquisition unit 152 acquires the sensibility information of each evaluator for each move of a Japanese chess game from the sensibility information DB 141.

The acquisition unit 152 acquires the degree of pleasantness (the value in the “pleasant-unpleasant” column) and the degree of intensity or calmness (the value in the “intense-calm” column) as the degree of emotion for each piece placement (move). The acquisition unit 152 also acquires information indicating the situation in the game for each piece placement (the value in the “situation” column).

The calculation unit 153 calculates the difference between the evaluators in the sensibility information for each move acquired by the acquisition unit 152. Here, the calculation unit 153 calculates the absolute value of the difference in sensibility information.

In the example of FIG. 6, the calculation unit 153 calculates the difference between the degree of pleasantness of the first evaluator and the degree of pleasantness of the second evaluator for the 60th move as “|0.7-(−0.9)|=1.6”. Furthermore, the calculation unit 153 calculates the difference between the degree of intensity of the first evaluator and the degree of intensity of the second evaluator for the 60th move as “|−0.7-(0.8)|=1.5”. The calculation unit 153 also calculates the difference between the situation of the first evaluator and the situation of the second evaluator for the 60th move as “|1900-(−1880)|=3780”.

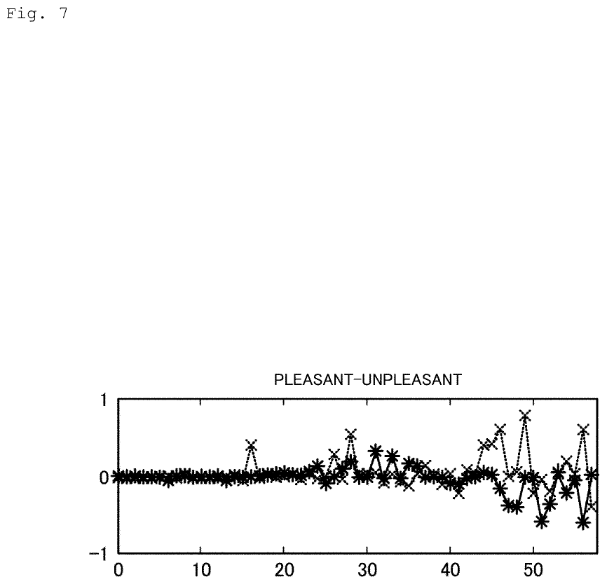

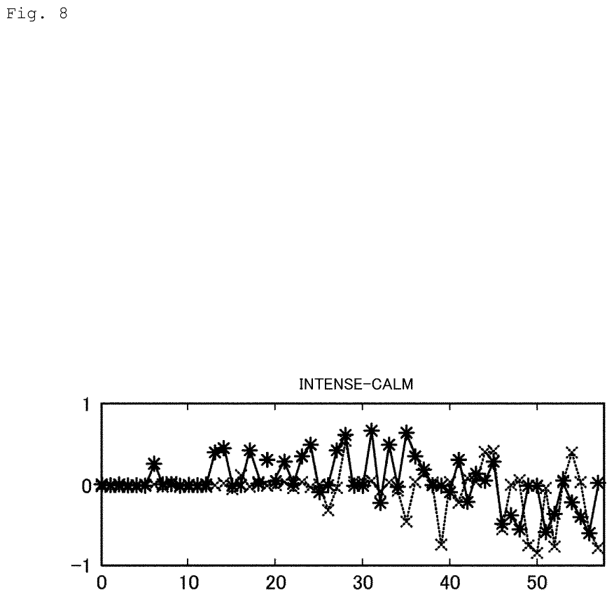

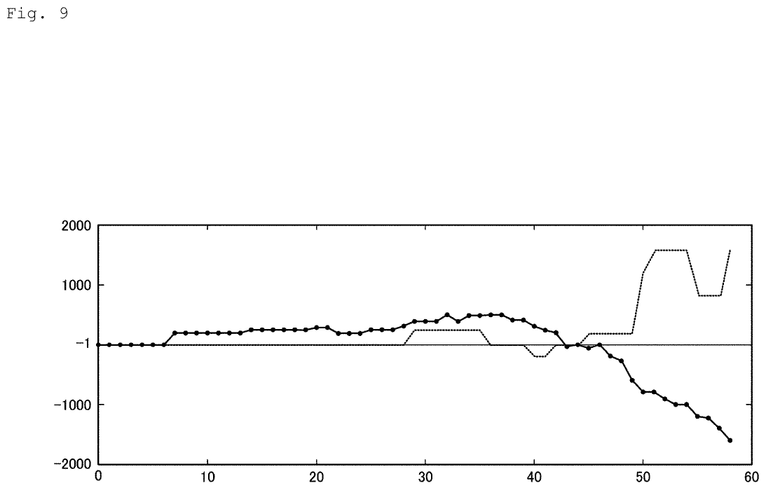

As illustrated in FIG. 7, FIG. 8, and FIG. 9, the difference in each piece of emotion information changes for each move. FIG. 7 is an example of a graph plotting values in the “pleasant-unpleasant” column. FIG. 8 is an example of a graph plotting values in the “intense-calm” column. FIG. 9 is an example of a graph plotting values in the “situation” column.

The dashed line in FIG. 7 indicates the degree of pleasantness for each move of the first evaluator. The solid line in FIG. 7 indicates the degree of pleasantness for each move of the second evaluator. The dashed line in FIG. 8 indicates the degree of intensity for each move of the first evaluator. The solid line in FIG. 8 indicates the degree of intensity for each move of the second evaluator. The dashed line in FIG. 9 indicates the situation for each move of the first evaluator. The solid line in FIG. 9 indicates the degree of situation for each move of the second evaluator.

The presentation unit 154 presents information obtained by comparing the degree of emotion felt by the first evaluator with the degree of emotion felt by the second evaluator. Here, the presentation unit 154 presents information acquired by the acquisition unit 152 for actions in which the difference between the degree of emotion felt by the first evaluator and the degree of emotion felt by the second evaluator is equal to or greater than a threshold.

That is, the presentation unit 154 extracts moves in which the difference calculated by the calculation unit 153 exceeds a threshold. The presentation unit 154 acquires information corresponding to the extracted moves from the sensibility information DB 141 and the game position information DB 142, and presents the information.

Note that the threshold may be determined in advance by the evaluator or the learner. The threshold may be changed in the early stage (for example, 1 to 20 moves), the middle stage (for example, 21 to 40 moves), and the end stage (for example, 41 to 60 moves) of a Japanese chess game.

The presentation unit 154 may also extract moves whose differences are included in a certain percentage of the top moves (for example, the top 6 moves (10%) out of 60 moves).

### [Processing Flow of First Embodiment]

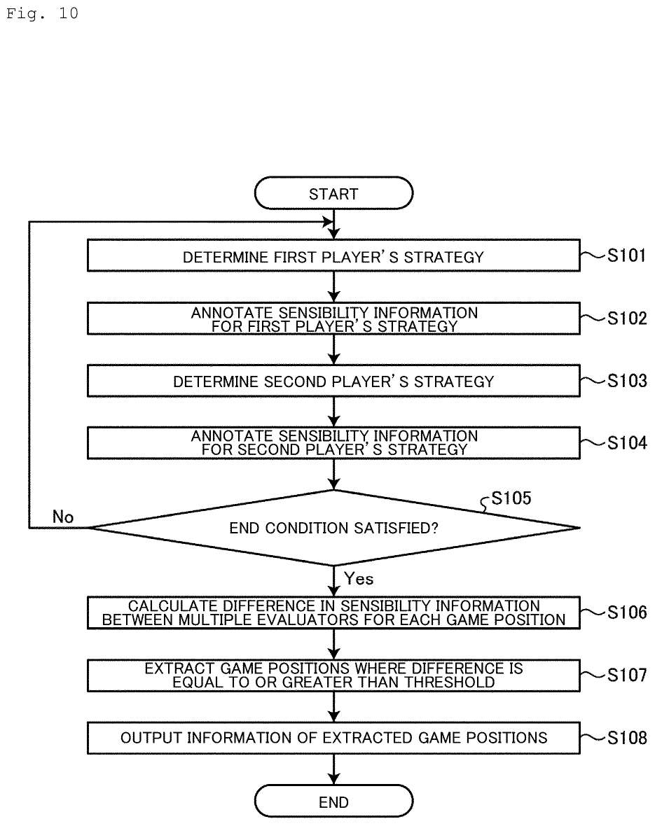

The processing flow of the information presentation device 10 will be described with reference to FIG. 10. FIG. 10 is a flowchart diagram for explaining the processing flow of the information presentation device of the first embodiment.

Here, it is assumed that two players are playing Japanese chess as before. It is also assumed that one of the players is the first player and the other is the second player. The evaluators may be players or observers.

It is also assumed that among the evaluators, the first evaluator is on the side of the first player, and the second evaluator is on the side of the second player. In other words, the first evaluator considers the situation value to be higher the more advantageous the first player is, and feels positive emotions such as happiness and joy when the first player wins. Conversely, the first evaluator considers the situation value to be lower the more disadvantageous the first player is, and feels negative emotions such as sadness and displeasure when the first player loses.

As illustrated in FIG. 10, first, the strategy of the first player is determined (step S101). That is, the first player changes the placement of the pieces.

The information presentation device 10 then annotates the first player's strategy with sensibility information (step S102). That is, the information presentation device 10 accepts input of emotion information from the first and second evaluators for the first player's strategy, and stores the input emotion information together with the game position information.

Next, the second player's strategy is determined (step S103). That is, the second player changes the placement of the pieces.

The information presentation device 10 then annotates the second player's strategy with sensibility information (step S104). That is, the information presentation device 10 accepts input of emotion information from the first and second evaluators for the second player's strategy, and stores the input emotion information together with the game position information.

The information presentation device 10 repeats the processing from step S101 to step S104 until the end condition is satisfied (step S105, No).

When the end condition is satisfied (step S105, Yes), the information presentation device 10 calculates the difference in the sensibility information between the multiple evaluators (here, between the first evaluator and the second evaluator) for each game position based on the stored emotion information (step S106).

Then, the information presentation device 10 extracts game positions in which the calculated difference is equal to or greater than a threshold (step S107) and outputs information on the extracted game positions (step S108). At this time, the information presentation device 10 may output the emotion information together with the game position information.

### [Effects of First Embodiment]

As described above, the information presentation device 10 has the acquisition unit 152 and the presentation unit 154. The acquisition unit 152 acquires the degree of emotion felt by the first evaluator and the degree of emotion felt by the second evaluator for each of a series of actions performed by a human. The presentation unit 154 presents information obtained by comparing the degree of emotion felt by the first evaluator and the degree of emotion felt by the second evaluator. For example, the presentation unit 154 presents information acquired by the acquisition unit 152 for actions in which the difference between the degree of emotion felt by the first evaluator and the degree of emotion felt by the second evaluator is equal to or greater than a threshold.

In the present embodiment, the presentation unit 154 presents information on the corresponding game position together with the emotion information. In other words, the presentation unit 154 presents a game position to be studied in which there is a large discrepancy in sensibility between the evaluators. For this reason, the learner and the evaluator can look back on the game while referring to the changes in the annotation for each presented move, and hold a discussion to deepen their understanding of the moves played. The learner may also look back on the game alone. In addition to the information presented by the presentation unit 154, the learner may refer to game record information and the like.

The learner may be a player or may be neither a player nor an evaluator.

For example, a case will be considered where the emotion information differs greatly between evaluators, such as a first evaluator's degree of pleasantness (value in the “pleasant-unpleasant” column) being close to 1 for a certain move during a game, and a second evaluator's degree of pleasantness being close to −1. In this case, by discussing why each evaluator felt that way about the move, it leads to the discovery and understanding of negative aspects that the first evaluator did not notice, positive aspects that the second evaluator did not notice, or aspects that each evaluator misunderstood.

A passion or outstanding ability, that is, a sharpened sensibility in a certain field, is often highly valuable. On the other hand, it is difficult for other people to understand and incorporate that sensibility and acquire a sharpened sensibility. Furthermore, with recent advances in AI, some AIs have been developed that surpass humans in some areas of ability, but even in these cases, it is difficult for humans to understand the capabilities of the AI.

According to the present embodiment, such sensibilities can be presented to the learner in a form that is easy to understand. For example, according to the present embodiment, in Japanese chess, a learner who has already reached the level of a professional Japanese chess player can become even stronger.

Furthermore, the application of the present embodiment is not limited to Japanese chess. The present embodiment can also be applied to other fields as long as it combines multiple sharpened sensibilities, or combines the sensibilities of a human who understands some of the excellent sensibilities of an AI to understand the sensibilities of an AI.

For example, the present embodiment can be applied to a series of actions in which a brand farmer observes subtle weather conditions and the condition of the plants, and cultivates crops with delicate adjustments that may be incomprehensible even to an average, excellent farmer.

The following are examples of specific effects of the present embodiment. In addition, in Japanese chess, players can compete in combinations such as both are human (human vs. human), one is AI (human vs. AI), or both are AI (AI vs. AI). These combinations of players are called game patterns.

[Effect 1: Clarifying Situations Where People's Perceptions Differ] (Game Patterns: Human vs. Human, AI vs. AI, Human vs. AI)

When reviewing and reflecting on the game record together with the information presented by the information presentation device 10, by referring to the annotations (emotion information), it becomes clear where there are differences in sensibilities that cannot be picked up through self-study or simply verbal exchanges between people.

Example (Japanese chess): In a pattern where two human evaluators teamed up to play against an AI, it becomes clear when one evaluator verbally agrees with his/her teammate's move, believing it to be good, while the other evaluator on the team thinks it's bad.

Example (Extension to general action): When human evaluators work together to achieve the same goal, they may not be able to fully communicate their methods, issues, or feelings toward the other person through verbal exchanges alone. By clarifying such feelings that do not surface in words as sensibility information, it becomes easier to notice diverse ways of thinking.

[Effect 2: Narrow Down Moves That Contain Important Lessons in Game Record] (Game Pattern: Human vs. Human, AI vs. AI, Human vs. AI)

The moves that correspond to the emotion information presented by the information presentation device 10 can be considered as moves for which the evaluators' sensibilities differ greatly. Since such moves can be considered to contain important lessons, narrowing the discussion to such moves allows for more efficient learning than following the game record from scratch.

Example (Extension to general action): Actions for which sensibilities differ greatly can be considered to contain important lessons, narrowing the discussion to such actions allows for more efficient learning than following all actions from scratch.

[Effect 3: Promoting Understanding of Moves Made by People who Play Japanese Chess in Different Style] (Game Pattern: Human vs. Human)

In the world of Japanese chess, a playing style is a distinguishing characteristic that reveals the type of strategy, fighting style, preference, and similar aspects. Typical playing styles are the “swinging rook party” and the “static rook party.” It is said that if players have different playing styles, even professional players may have difficulty understanding each other's moves. To facilitate understanding between players with different styles, two players with different playing styles are pitted against each other.

The playing styles of the two competing players are referred to as Style A and Style B, respectively, and there are evaluators with Style A and Style B. In this case, the results of moves made by Style A and annotated by an evaluator with Style A, are considered to strongly reflect the thinking of Style A. By referring to the annotation results, a player with Style B can learn more about the thinking of Style A.

Similarly, a player with style A can learn more about the way of thinking of style B.

Example (Japanese chess): By referring to the sensibility information of an evaluator with the “swinging rook party” style, a player with the “static rook party” style can grasp the tendency of the way of thinking about the moves of the player with the “swinging rook party” style.

Example (Extension to agriculture): By referring to the sensibility information regarding cultivation of a rare crop A, of a brand farmer A himself as an evaluator, who has made exquisite adjustments to cultivate the rare crop A, a brand farmer B can obtain hints on how to further enhance the cultivation of a rare crop B he is growing.

[Effect 4: Facilitating Understanding of Difficult Strong Moves Made by Japanese Chess AI] (Game Patterns: AI vs. AI, Human vs. AI)

Even professional players have difficulty understanding the moves of Japanese chess AI, which are stronger than humans. However, each evaluator can understand at least a part of the AI's moves, and this is thought to be reflected in the discrepancies in the annotated sensibility information. The evaluators discuss the parts of the sensibility information that differ, and share what each evaluator understands among themselves, which can facilitate understanding of the Japanese chess AI's moves.

Example (Japanese chess): When an AI makes a move that a player with the “swinging rook party” style cannot understand at all, but a player with the “static rook party” style knows a similar move, or conversely, when a player with the “swinging rook party” style knows a move that only a player with the “swinging rook party” style understands, the two players can complement each other's understanding and improve the understanding of the AI's move.

Example (Extension to agriculture): When attempting to cultivate a rare plant that only grows naturally on an island, farmers A and B observe different points about its cultivation, and establish a cultivation method by sharing these points and complementing each other's insights.

[Effect 5: Efficient Learning That can Simultaneously Achieve Effects 1 To 4 in one Game] (Game Pattern: Human vs. AI)

A case will be considered where two humans with different playing styles team up (not limited to two people, but for clarity, we use a pair here) and compete against a formidable Japanese chess AI. In this case, the two humans with different playing styles are the evaluators. This makes it possible to obtain effects such as clarifying the differences in sensibility between people (effect 1), clarifying the differences in sensibility due to playing style (effect 2), and facilitating understanding of AI's moves (effect 3) through learning from a single game.

### [System Configuration and the Like]

In addition, each component of each illustrated device is functionally conceptual, and does not necessarily need to be physically configured as illustrated. That is, a specific form of distribution and integration of devices is not limited to the illustrated form, and all or a part thereof can be functionally or physically distributed or integrated in any unit according to various loads, usage conditions, and the like. Furthermore, all or some of the processing functions performed by each device may be realized by a CPU (Central Processing Unit) and a program that is analyzed and executed by the CPU, or may be realized as hardware using wired logic. The program may be executed not only by the CPU but also by another processor such as a GPU.

In addition, among the processes described in the embodiment, all or some of the processes described as being automatically performed can be manually performed or, alternatively, all or some of the processes described as being manually performed can be automatically performed by known methods. Furthermore, information including processing procedures, control procedures, specific names, various data and parameters having been described above or illustrated in the drawings may be arbitrarily changed unless otherwise described.

### [Program]

As one embodiment, the information presentation device 10 can be implemented by installing an information presentation program for executing the above information presentation processing on a desired computer as package software or online software. For example, an information processing device can be caused to function as the information presentation device 10, by causing the information processing device to execute the above information presentation program. The information processing device mentioned herein includes a desktop or a laptop personal computer. In addition, the information processing device may also include mobile communication terminals such as smartphones, mobile phones, and personal handyphone systems (PHSs), XR devices such as all-in-one AR glasses and VR goggles, and slate terminals such as personal digital assistants (PDAs) and tablet terminals.

The information presentation device 10 may also be implemented as an information presentation server device that provides services related to the above-mentioned information presentation process to a client, the client being a terminal device used by a user. For example, the information presentation server device is implemented as a server device that provides an information presentation service that receives as input the sensibility information of an evaluator and outputs the sensibility information with a large difference between evaluators and the information of the corresponding game position. In this case, the information presentation server device may be implemented as a Web server, or may be implemented as a cloud that provides services related to the above-mentioned information presentation process by outsourcing.

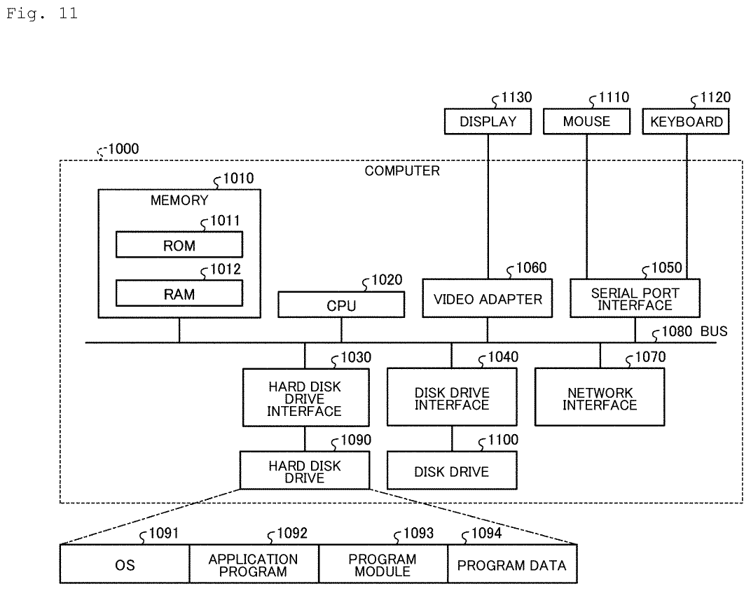

FIG. 11 is a diagram illustrating an example of a computer that executes the information presentation program. A computer 1000 includes, for example, a memory 1010 and a CPU 1020. Further, the computer 1000 also includes a hard disk drive interface 1030, a disk drive interface 1040, a serial port interface 1050, a video adapter 1060, and a network interface 1070. These units are connected by a bus 1080.

The memory 1010 includes a read only memory (ROM) 1011 and a random access memory (RAM) 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disc is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and program data 1094. That is, a program that defines each process of the information presentation device 10 is implemented as a program module 1093 in which computer-executable codes are written. The program module 1093 is stored in, for example, the hard disk drive 1090. For example, the program module 1093 for executing a process similar to the functional configuration of the information presentation device 10 is stored in the hard disk drive 1090. The hard disk drive 1090 may be replaced with a solid state drive (SSD).

Furthermore, the setting data used in the processing of the above-described embodiment is stored, for example, in the memory 1010 or the hard disk drive 1090 as the program data 1094. The CPU 1020 reads the program module 1093 or the program data 1094 stored in the memory 1010 or the hard disk drive 1090 into the RAM 1012 as necessary, and executes the processing of the above-described embodiment.

Note that the program module 1093 and the program data 1094 are not limited to being stored in the hard disk drive 1090, and may be stored in, for example, a detachable storage medium and read by the CPU 1020 via the disk drive 1100 or the like. Alternatively, the program module 1093 and the program data 1094 may be stored in another computer connected via a network (a local area network (LAN), a wide area network (WAN), or the like). Then, the program module 1093 and the program data 1094 may be read by the CPU 1020 from another computer via the network interface 1070.

### REFERENCE SIGNS LIST

10 Information presentation device
11 Communicating part
12 Input unit
13 Output unit
14 Storage unit
15 Control unit
141 Sensibility information DB
142 Game position information DB
151 Display control unit
152 Acquisition unit
153 Calculation unit
154 Presentation unit

1. An information presentation device comprising:
a memory; and
processing circuitry configured to:
acquire a degree of emotion felt by a first evaluator and the degree of emotion felt by a second evaluator for each of a series of actions performed by a human; and
present information obtained by comparing the degree of emotion felt by the first evaluator with the degree of emotion felt by the second evaluator.

2. The information presentation device according to claim 1, wherein the processing circuitry is further configured to present information acquired for actions in which a difference between the degree of emotion felt by the first evaluator and the degree of emotion felt by the second evaluator is equal to or greater than a threshold among the series of actions.

3. The information presentation device according to claim 1, wherein the processing circuitry is further configured to acquire the degree of emotion felt by the first evaluator and the degree of emotion felt by the second evaluator for each piece placement by each player in a board game in which two players alternately place pieces to play against each other.

4. The information presentation device according to claim 3, wherein the processing circuitry is further configured to acquire a degree of pleasantness and a degree of intensity or calmness as the degree of emotion for each piece placement.

5. The information presentation device according to claim 4, wherein the processing circuitry is further configured to acquire information indicating a situation in a game for each piece placement.

6. An information presentation method comprising:
acquiring a degree of emotion felt by a first evaluator and the degree of emotion felt by a second evaluator for each of a series of actions performed by a human; and
presenting information acquired for actions in which a difference between the degree of emotion felt by the first evaluator and the degree of emotion felt by the second evaluator is equal to or greater than a threshold among the series of actions.

7. A non-transitory computer-readable recording medium storing therein an information presentation program that causes a computer to execute a process comprising:
acquiring a degree of emotion felt by a first evaluator and the degree of emotion felt by a second evaluator for each of a series of actions performed by a human; and
presenting information acquired for actions in which a difference between the degree of emotion felt by the first evaluator and the degree of emotion felt by the second evaluator is equal to or greater than a threshold among the series of actions.
